(19) United States
(12) Patent Application Publication
(10) Pub. No.: US 2011/0106413 A1
(43) Pub. Date: May 5, 2011

(54) APPARATUS AND METHOD FOR IDLING CONTROL OF A VEHICLE

(75) Inventors: Byoung-Jun PARK, Daejeon (KR); Myunghee SON, Daejeon (KR)

(73) Assignee: Electronics and Telecommunication Research Institute, Daejeon (KR)

(21) Appl. No.: 12/899,005

(22) Filed: Oct. 6, 2010

(30) Foreign Application Priority Data
Nov. 4, 2009 (KR) 10-2009-0106128
Jun. 1, 2010 (KR) 10-2010-0051799

(51) Int. Cl. F02D 41/04; F02D 41/08

(52) U.S. Cl. 701/112; 701/115

(57) ABSTRACT

An idling control apparatus for a vehicle includes an engine control unit for determining an idling state of the vehicle, in which the vehicle is stopped while an engine is in a turned-on state, to control the engine of the vehicle based on information of a traffic signal. The engine control unit maintains the turned-on state of the engine or turns off the engine depending on a residual time of the traffic signal when it is determined that the vehicle is in the idling state. Further, the engine control unit turns off the engine of the vehicle when a stop time of the vehicle is longer than a predetermined idling time limit, wherein the stop time is calculated by subtracting from a point in current time by a point in time at which it is determined that the vehicle is in the idling state.

### CROSS-REFERENCE(S) TO RELATED APPLICATION(S)

The present invention claims priority of Korean Patent Applications No. 10-2009-0106128, filed on Nov. 4, 2009, and No. 10-2010-0051799, filed on Jun. 1, 2010, which are incorporated herein by reference.

### FIELD OF THE INVENTION

The present invention relates to an idling control of a vehicle, and more particularly, to an idling control apparatus and method for a vehicle when the vehicle stops for a predetermined period of time, as well as when the vehicle waits for a traffic signal to change.

### BACKGROUND OF THE INVENTION

As well known in the art, the habitual idling of a vehicle by a driver not only wastes energy, but may cause suffocation in a hermetically sealed space, and can be a contributing factor to air pollution.

Most of the conventional technologies for preventing idling in a vehicle involve an idling control technique performed only when the vehicle waits for a traffic signal or when the vehicle is stopped for a predetermined period of time.

Thus, such conventional techniques have such deficiencies as their inability to control idling of a vehicle when the vehicle is stopped for reasons other than waiting for a traffic signal, and their inability to control fuel consumption by way of restarting upon a change to a green traffic signal in spite of traffic congestion.

In addition, a technique primarily designed to control idling when the vehicle is stopped for a predetermined period of time only is not normally configured to automatically restart the vehicle upon a change to a green traffic signal after waiting for a traffic signal.

### SUMMARY OF THE INVENTION

Accordingly, the present invention provides an idling control apparatus and method for a vehicle, capable of performing an idling control of a vehicle when the vehicle is stopped for a predetermined period of time during, e.g., traffic congestion, as well as when the vehicle waits for a traffic signal.

Further, the present invention provides an idling control apparatus and method for a vehicle, capable of restarting the vehicle upon a change to a green traffic signal after waiting for a traffic signal.

In accordance with an aspect of the present invention, there is provided an idling control apparatus for a vehicle, including:

an engine state checking unit for checking an on/off state of an engine of the vehicle;

a movement checking unit for detecting a movement of the vehicle;

an information receiving unit for collecting information on traffic signals of a signal light; and

an engine control unit for determining an idling state of the vehicle in which the vehicle is stopped while the engine is in an on state in order to control the engine of the vehicle based on the traffic signal information.

In accordance with another aspect of the present invention, there is provided an idling control method for a vehicle, including:

determining an idling state of the vehicle in which the vehicle is stopped while an engine of the vehicle is turned on, or the vehicle is moved below a predetermined speed;

determining whether the idling state is caused by a traffic signal; and

turning off the engine of the vehicle if the vehicle is idling due to the traffic signal.

### BRIEF DESCRIPTION OF THE DRAWINGS

The above and other objects and features of the present invention will become apparent from the following description of embodiments, given in conjunction with the accompanying drawings, in which:

FIG. 1 is a block diagram of an idling control apparatus for a vehicle in accordance with an embodiment of the present invention;

FIG. 2 shows a view for explaining an idling state of a vehicle;

FIG. 3 is a flowchart illustrating a process in which the idling control apparatus determines the idling state of the vehicle and then switches off the engine of the vehicle in accordance with the embodiment of the present invention; and

FIG. 4 is a flowchart illustrating a process for restarting the stopped vehicle engine upon a change to a green traffic signal in accordance with the embodiment of the present invention.

### DETAILED DESCRIPTION OF THE EMBODIMENTS

The advantages and features of the present invention, as well as the method of accomplishing the objectives of the invention, will be clearly understood through the following embodiments taken in conjunction with the accompanying drawings. However, the present invention is not limited to those embodiments but may be implemented in various forms. It should be noted that the present embodiments are provided to make a full disclosure of the invention and also to allow those skilled in the art to appreciate the full range of the invention. Therefore, the present invention is to be defined only by the scope of the appended claims.

Hereinafter, embodiments of the present invention will be described with reference to the accompanying drawings, wherein like reference numerals identify like elements throughout the specification.

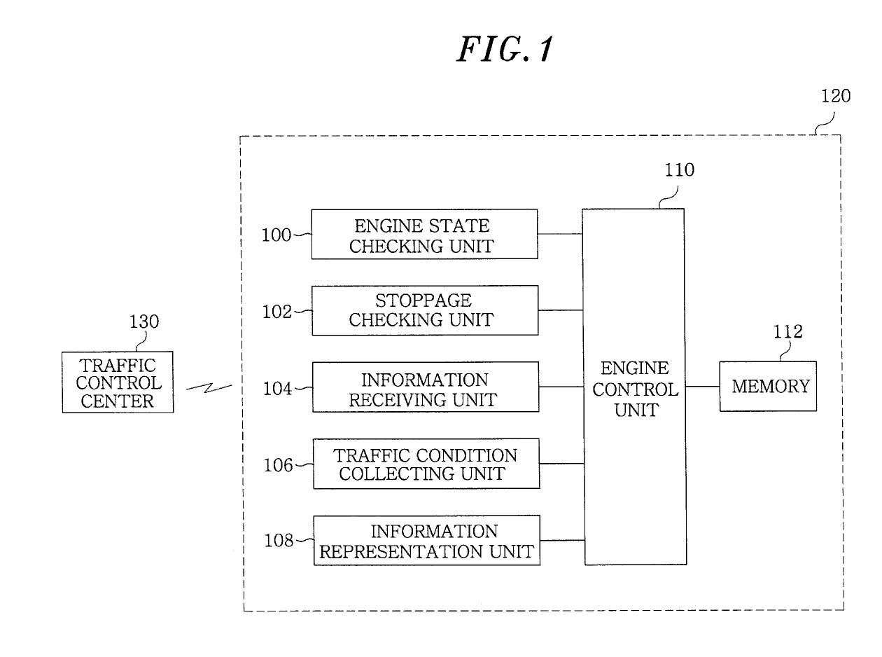

FIG. 1 is a block diagram of an idling control apparatus for a vehicle in accordance with an embodiment of the present invention.

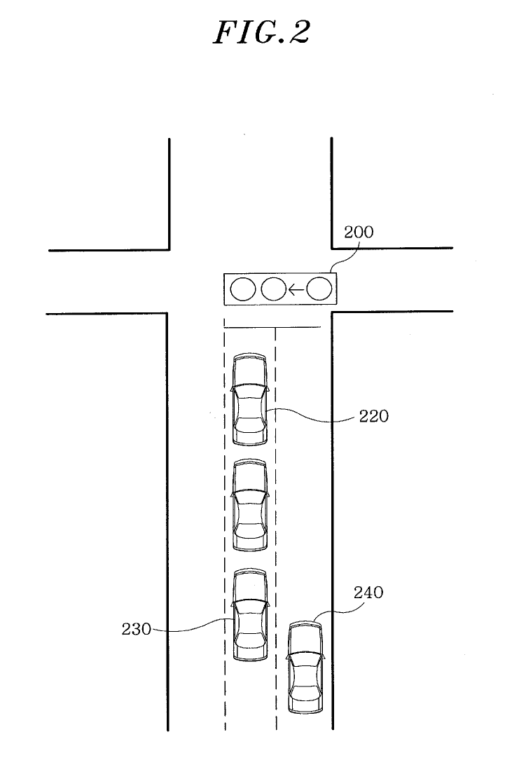

The embodiment of the invention is adapted to detect an idling state of a vehicle when the vehicle stops for a predetermined period of time, as well as when the vehicle waits for a traffic signal. In an example, as shown in FIG. 2, if a vehicle 220 is stopped while waiting for a traffic light 200, the engine of the vehicle 220 is turned off during a residual time of a red traffic signal and then restarted upon a change to a green traffic signal or when the vehicle's driver desires to restart. Also, if a vehicle 230 stands without movement even if the traffic signal turns green during traffic congestion, the engine of the vehicle 230 is not switched on but maintained in the off state. Furthermore, if a vehicle 240 is stopped regardless of the traffic signal, the engine of the vehicle 240 is turned off upon occurrence of the idling state for a certain period of time, and the vehicle 240 is restarted when a driver desires to restart.

Referring again to FIG. 1, the idling control apparatus includes an engine state checking unit 100, a movement checking unit 102, an information receiving unit 104, a traffic condition collecting unit 106, an information representation unit 108, and an engine control unit 110. All of the components are installed in a vehicle 120. In the embodiments of the present invention, the vehicle may be an automobile, a motorcycle or the like.

The engine state checking unit 100 checks the engine state of the vehicle 120 in order to determine an on/off state of an engine of the vehicle 120.

The movement checking unit 102 detects the movement of the vehicle 120 and then provides the detected movement or stop state of the vehicle to the engine control unit 110. For example, the movement or stop state of the vehicle may be detected by sensing the action of the wheels of the vehicle 120 using a movement sensor.

The information receiving unit 104 communicates wirelessly with a traffic control center 130 capable of providing information on traffic signals represented on a traffic light 200. The traffic signal information received by the information receiving unit 104 is then provided to the engine control unit 110. Alternatively, the information receiving unit 104 may obtain the traffic signal information through the use of a vision sensor.

The traffic condition collecting unit 106 collects information through wireless communications on traffic conditions around the vehicle 120, such as a traffic jam, from the traffic control center 130. Alternatively, the traffic condition collecting unit 106 may obtain the traffic condition information by calculating the distance between the vehicle 120 and its neighboring vehicles, using, but not limited to, an ultrasonic sensor, a vision sensor, or the like. The collected traffic condition information is supplied to the engine control unit 110.

The engine control unit 110 determines whether the vehicle 120 is idling based on the movement of the vehicle detected by the movement checking unit 102. A point in time to at which the vehicle is determined as being in an idling state is registered into a memory 112. Also, the engine control unit 110 determines whether the vehicle 120 has now stopped at a red traffic signal upon determination of the idling state.

In addition, the engine control unit 110 obtains a residual time of a red traffic signal based on the traffic signal information and determines whether it is appropriate to turn off the engine during the residual time of the red traffic signal. If so, the engine control unit 110 turns off the engine of the vehicle. Here, it is preferable that the decision to turn off the engine during the residual time of the red traffic signal be made by taking into account the time required for restarting, the amount of fuel consumed for restarting, the emission of harmful exhaust gas and the like. For example, if the time required to restart takes longer than the residual time of the red traffic signal, it is preferable that the vehicle maintains the idling state. However, in a case where the stopping of the vehicle is not caused by the red traffic signal, the engine control unit 210 calculates a stop time during which the vehicle is stopped. Here, the stop time of the vehicle can be obtained by calculating the difference between the point in time T₀ when the vehicle is determined as idling and a point in current time T_{c}. If the calculated stop time of the vehicle exceeds a predetermined idling time limit T_{isg} the engine control unit 110 turns off the engine of the vehicle.

In addition, the engine control unit 110 performs the control of the engine of the vehicle, from an engine off state to an engine on state, depending on the traffic conditions received from the traffic condition collecting unit 106. For example, if the traffic condition is congested, the engine control unit 110 may maintain the engine off state. On the other hand, if there will be no change to a green traffic signal, it detects whether the driver's operation is present so as to switch on the engine.

When the engine of the vehicle is switched off or switched on under the control of the engine control unit 110, the information representation unit 108 indicates the state of the vehicle, e.g., idling state, movement/braking, engine on/off state and the like. This state information may then be provided to the driver in the form of voice, display, text, etc.

In accordance with the embodiment of the present invention, when performing the idling control of the vehicle, the engine on/off state of the vehicle can be controlled even when the vehicle is stopped for a predetermined period of time, as well as when the vehicle waits for a red signal, thereby minimizing the vehicle idling and emission of harmful exhaust gas.

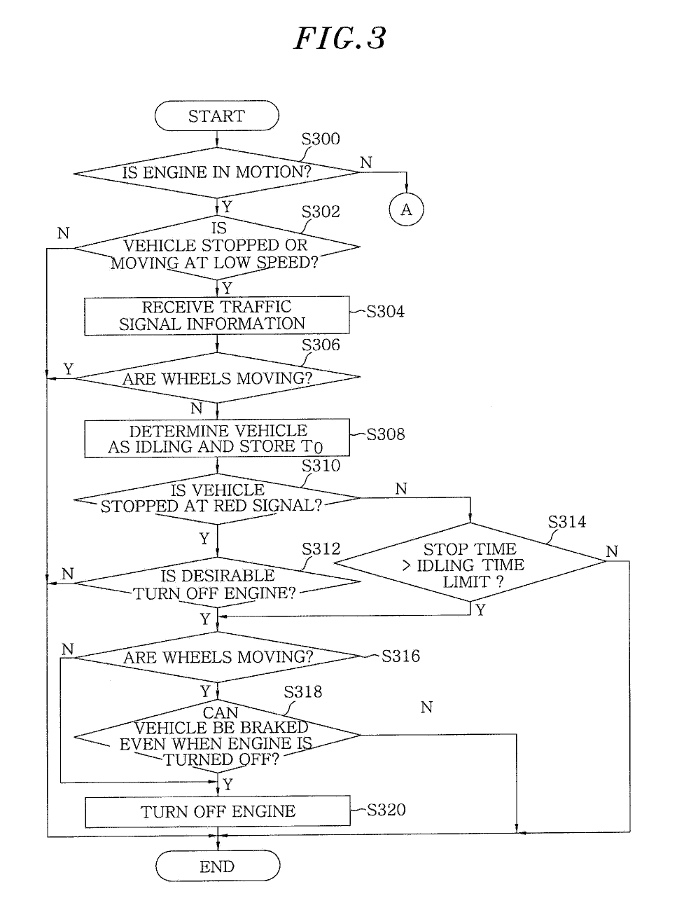

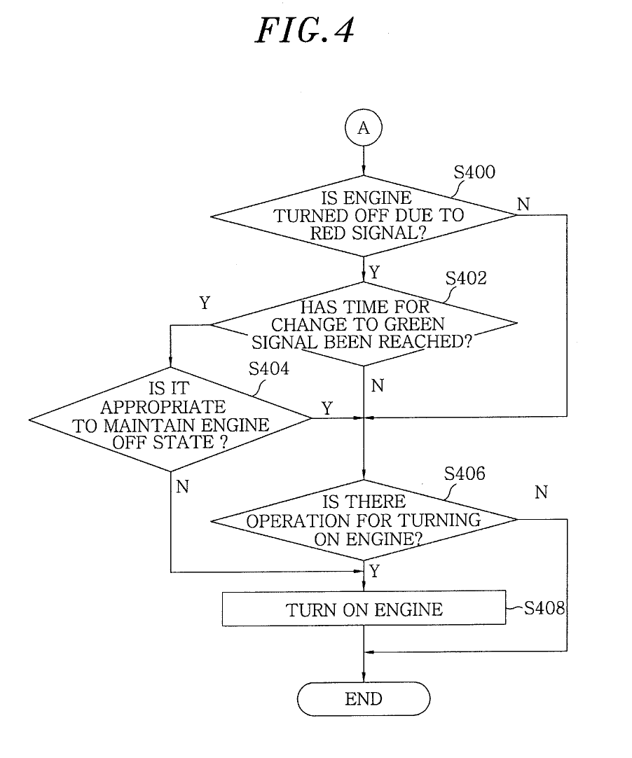

The inventive process for determining the idling state of the vehicle and then turning on or off the engine of the vehicle will now be described with reference to FIGS. 3 and 4.

FIG. 3 is a flowchart illustrating a process for determining the idling state of the vehicle and then turning off the engine of the vehicle in accordance with the embodiment of the present invention.

As shown in FIG. 3, the idling control process checks the state of the engine in step S300, by the engine state checking unit 100, in order to detect the engine's on/off state of a vehicle 120.

Following the checking process in step S300, if the engine of the vehicle is turned on, the process proceeds to step S302, or if the engine of the vehicle is turned off, the process advances to step S400 through a tab ‘A’, as shown in FIG. 4.

In step S302, the idling control process determines whether the vehicle 120 has stopped or is moving at a low speed, e.g., below 10 km per hour, by checking the movement of the wheels of the vehicle 120 through the use of the movement checking unit 102.

As a result of the checking process in step S302, if the vehicle 120 is stopped or moving at low speed, the idling control apparatus receives traffic signal information from the traffic control center 130 through the information receiving unit 104 and then calculates a residual time of a red traffic signal based on the traffic signal information in step S304.

Next, in step S306, the idling control process determines whether the vehicle 120 is moving, i.e., whether there is a movement of the wheels of the vehicle 120 through the movement checking unit 102.

As a result of the determination in step S306, if the vehicle is moving, the engine is not turned off and the idling control process ends.

If, however, the wheels of the vehicle 120 are not moving or the vehicle is moving at a low speed, the idling control apparatus determines that the vehicle 120 is currently idling while stopped, and stores in the memory 112 the time T₀ when the vehicle is determined as idling in step S308.

Thereafter, the idling control process determines whether the vehicle 120 stopped due to a red traffic signal based on the traffic signal information in step S310. As a result of the decision made in step S310, if the vehicle 120 is stopped due to the red traffic signal, the idling control process determines whether it is desirable or necessary to switch off the engine during the residual time of the red traffic signal in consideration of the time required for restarting, the amount of fuel consumed for restarting, the discharge of harmful exhaust gas and the like, in step S312.

As a result of the decision in step S312, if it is determined inappropriate to switch off the engine during the red traffic signal, the engine is not switched off and the idling control process ends.

However, if it is determined desirable to switch off the engine during the residual time of the red traffic signal, the process advances to step S316.

Meanwhile, as a result of the decision in step S310, however, if the vehicle 120 is not stopped at the red traffic signal, the idling control process determines whether a stop time of the vehicle 120 is longer than a predetermined idling time limit T_{isg} in step S314. Here, the stop time may be obtained by subtracting the time T₀ when the vehicle is determined as idling from a current time T_{c}. As a result of the determination in step S314, if the stop time is shorter than the predetermined idling time limit T_{isg}, the engine is not turned off and the method ends.

As a result of the determination in S314, however, if it is determined that the stop time of the vehicle 120 is longer than the predetermined idling time limit T_{isg}, that is, the vehicle is stopped beyond the predetermined idling time limit T_{isg}, the idling control process proceeds to step S316.

In step S316, the idling control process determines the movement of the wheels of the vehicle 120, for example, the idling control process determines if the wheels are moving. Next, as a result of the determination in step S316, if the wheels of the vehicle 120 are moving, the idling control process checks if the vehicle 120 can be braked even when the engine is turned off in step S318.

As a result of the checking process in step S318, if the vehicle 120 cannot be braked when the engine is turned off, the idling control process maintains the turned-on state of the engine and the idling control process ends.

As a result of the checking process in step S318, however, if the vehicle 120 can be braked even when the engine is turned off, the engine is turned off under the control of the engine control unit 110 in step S320 and the idling control process ends.

In accordance with the embodiment of the present invention, the idling control of the vehicle is performed when the vehicle has stopped for a predetermined period of time during traffic congestion, as well as when the vehicle waits for a traffic signal to change, thereby conserving fuel for the vehicle and reducing the emission of harmful exhaust gas such as carbon dioxide.

FIG. 4 is a flowchart illustrating a process for turning on the engine when the engine of the vehicle is in a turned-off state in accordance with the embodiment of the present invention.

As shown in FIG. 4, in step 400, the idling control process determines whether the engine is turned off while the vehicle 120 is stopped at a red traffic signal.

As a result of the determination in step S400, if positive, the idling control process advances to step S402. But if negative, the idling control process goes to step S406.

In step 402, the idling control process determines if the time for the red traffic signal to turn green has been reached based on the traffic signal information received by the information receiving unit 104.

As a result of the determination in step S402, if positive, the idling control process advances to step S404. But if negative, the idling control process goes to step S406.

In step S404, the idling control process determines whether it is appropriate for the vehicle to maintain the engine off state in consideration of traffic congestion based on traffic condition information collected from the traffic control center 130.

As a result of the determination in step S404, if positive, the idling control process advances to step S406, or if negative, the idling control process goes to step S408.

In step S406, the idling control process checks whether an operation for turning on the engine by the driver is present.

If the operation for turning on the engine by the driver is present, the idling control process turns on the engine of the vehicle in step S408 and the idling control process ends. However, if no operation for turning on the engine is present, the idling control process maintains the turned-off state of the vehicle and the idling control process ends.

While the invention has been shown and described with respect to the particular embodiments, it will be understood by those skilled in the art that various changes and modifications may be made without departing from the scope of the present invention as defined in the following claims.

What is claimed is:

1. An idling control apparatus for a vehicle, comprising:
an engine state checking unit for checking an on/off state of an engine of the vehicle;
a movement checking unit for detecting a movement of the vehicle;
an information receiving unit for collecting information on traffic signals of a signal light; and
an engine control unit for determining an idling state of the vehicle, in which the vehicle is stopped while the engine is in a turned-on state, to control the engine of the vehicle based on the traffic signal information.

2. The idling control apparatus of claim 1, wherein the engine control unit maintains the turned-on state of the engine or turns off the engine depending on a residual time of the traffic signal when it is determined that the vehicle is in the idling state.

3. The idling control apparatus of claim 1, further comprising a traffic condition collecting unit for collecting information on traffic conditions around the vehicle,
wherein the engine control unit turns on the engine of the vehicle or maintains a turned-off state depending on the traffic condition when there is a change of the traffic signal after the engine of the vehicle is turned off.

4. The idling control apparatus of claim 3, wherein the engine control unit turns off the engine of the vehicle when a stop time period of the vehicle is longer than a predetermined idling time limit, and
wherein the stop time is calculated by subtracting from a point in current time by a point in time at which it is determined that the vehicle is in the idling state.

5. The idling control apparatus of claim 4, wherein the engine control unit checks the movement of the vehicle before turning off the engine of the vehicle and then turns off the engine of the vehicle if there is no further movement of the vehicle.

6. The idling control apparatus of claim 5, wherein the engine control unit turns off the engine only if the vehicle can be braked even when the engine of the vehicle is turned off if the movement of the vehicle is present.

7. The idling control apparatus of claim 1, wherein the movement of the vehicle is obtained by checking the movement of the wheels of the vehicle.

8. An idling control method for a vehicle, comprising:
determining an idling state of the vehicle in which the vehicle is stopped while an engine of the vehicle is turned on, or the vehicle moves at a speed below a predetermined speed limit;
determining whether the idling state is caused by a traffic signal; and
turning off the engine of the vehicle if the vehicle is idling due to the traffic signal.

9. The idling control method of claim 8, further comprising:
before said turning off the engine of the vehicle, determining whether it is appropriate to turn off the engine of the vehicle during a residual time of the traffic signal.

10. The idling control method of claim 8, further comprising:
before said turning off the engine of the vehicle, determining whether the vehicle can be braked even when the engine is turned off if a movement of the vehicle is present.

11. The idling control method of claim 8, further comprising:
if the idling state of the vehicle is not caused by the traffic signal,
calculating a stop time of the vehicle during which the vehicle is stopped; and
turning off the engine of the vehicle when the stop time is longer than a predetermined idling time limit.

12. The idling control method of claim 11, wherein the stop time is calculated by subtracting from a point in current time by a point in time at which it is determined that the vehicle is in the idling state.

13. The idling control method of claim 11, further comprising:
before said turning off the engine of the vehicle, determining whether the vehicle can be braked even when the engine is turned off if movement of the vehicle is present.

14. The idling control method of claim 8, further comprising:
determining whether a time for the traffic signal to change to another traffic signal has been reached;
determining whether it is appropriate for the vehicle to maintain the engine off state based on traffic conditions around the vehicle; and
determining whether there is an operation by a vehicle driver to turn on the engine.

15. The idling control method of claim 14, wherein if the time for a change to said another signal has not been reached and there is no operation by a vehicle driver to turn the engine on, the turned-off state of the engine is maintained.

16. The idling control method of claim 14, wherein, if it is determined inappropriate for the vehicle to maintain the engine off state and when there is no operation by a vehicle driver to turn the engine on, the turned-off state of the engine is maintained.
